(19) United States
(12) Patent Application Publication
(10) Pub. No.: US 2010/0241317 A1
(43) Pub. Date: Sep. 23, 2010

(54) Activation device for passenger protection system and acceleration sensor module therefor

(75) Inventors: Takashi Mihara, Niwa-gun (JP); Yukiyasu Ueno, Nishio-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/661,157

(22) Filed: Mar. 11, 2010

(30) Foreign Application Priority Data
Mar. 18, 2009 (JP) 2009-066090

(51) Int. Cl. B60R 21/0132; B60R 21/0136; G01P 15/00

(52) U.S. Cl. 701/46; 701/45; 73/514.01

(57) ABSTRACT

An acceleration sensor module is provided with sensor chips, first and second collision check sections and an OR circuit so that accelerations in different detection directions can be detected. The sensor chips of the acceleration sensor module can thus be used as a redundancy sensor in an activation device for a passenger protection system. The passenger protection system is thus prevented form being erroneously activated by only an output signal of a microcomputer, because the first switch section is controlled by both outputs of the acceleration sensor module and the microcomputer.

### CROSS REFERENCE TO RELATED APPLICATION

This application is based on and incorporates herein by reference Japanese patent application No. 2009-66090 filed on Mar. 18, 2009.

### FIELD OF THE INVENTION

The present invention relates to an activation device for a passenger protection system mounted on a vehicle and an acceleration sensor module for use in such an activation device.

### BACKGROUND OF THE INVENTION

It is conventionally proposed, for example, by JP 2006-88824A that an activation control device activates a passenger protection system such as an airbag system, when a vehicle collides with other vehicles or obstacles. This activation control device is configured by two microcomputers, main microcomputer and a sub-microcomputer, and a firing driver integrated circuit (IC).

The main microcomputer performs a main collision check about collision by using an acceleration (G) sensor as a main G sensor. The sub-microcomputer performs a safing check about collision by using another acceleration (G) sensor as a safing G sensor different from the main G sensor. The firing driver IC activates the passenger protection system by driving a switching element based on the main collision check result and the safing check result. In case of ensuring redundancy by thus using a plurality of sensors, both G sensors for the main collision check operation and the safing check operation are required to detect the same collision. Therefore, both G sensors are arranged to detect the collision in the same directions, that is, to have the same collision detection axes.

Specifically, the igniter driver IC activates the passenger protection system by turning on the switching element, only when the main microcomputer determines that the main G sensor has detected a large collision impact applied to the vehicle and the sub-microcomputer also has detected the large collision impact of the vehicle.

Thus, the main G sensor is used for performing the main collision check by the main microcomputer, and the safing G sensor is used for performing the safing check. As a result, the passenger protection system is prevented from operating erroneously, even when either one of the microcomputers runs erroneously due to mechanical, thermal or electrical influence.

The activation device for the passenger protection system according to the conventional technology, two microcomputers are used, one being in correspondence to the main G sensor and the other being in correspondence to the safing G sensor. As a result, the activation device becomes large-sized.

It is possible to provide only one microcomputer in the activation device and activate the passenger protection system based on only the check result of such one microcomputer. It is however not preferred to reduce simply the number of microcomputers, because the passenger protection system will be activated erroneously when the microcomputer runs erroneously.

### SUMMARY OF THE INVENTION

It is therefore an object of the present invention to provide an activation device for a passenger protection system and an acceleration sensor module for such an activation device, which is simple in construction and free from erroneous operation.

According to one aspect of the present invention, an acceleration sensor module is configured with an acceleration detection section, a first collision check section, a second collision check section and an output section.

The acceleration detection section includes a first acceleration sensor and a second acceleration sensor. The first acceleration sensor detects an acceleration in a first direction parallel to a first detection axis, and the second acceleration sensor detects an acceleration in a second direction parallel to a second detection axis, which is different from the first detection axis. The acceleration detection section is configured to output a first detection signal corresponding to the acceleration detected by the first acceleration sensor and a second detection signal corresponding to the acceleration detected by the second acceleration sensor. The first collision check section has a first threshold value for checking whether an impact has been applied in the first direction. The first collision check section is configured to receive the first detection signal and check whether a first detection value corresponding to the first detection signal exceeds the first threshold value. The second collision check section has a second threshold value for checking whether an impact has been applied in the second direction. The second collision check section is configured to receive the second detection signal and check whether a second detection value corresponding to the second detection signal exceeds the second threshold value. The output section is configured to receive check results of the first collision check section and the second collision check section and produce an output signal when at least one of the check results indicates that the first detection value exceeds the first threshold value or the second detection value exceeds the second threshold value.

The acceleration sensor module is used as a part of an activation device for passenger protection systems.

According to another aspect of the present invention, an activation device for a passenger protection system of a vehicle is configured with an acceleration sensor module, a main acceleration sensor, a microcomputer, a first switch section and a second switch section.

The acceleration sensor module includes a safing acceleration sensor and a safing check section. The safing acceleration sensor detects an acceleration in a predetermined direction and produces a detection signal corresponding to detected acceleration. The safing check section compares a safing detection value calculated based on the detection signal of the safing acceleration sensor with a safing reference value. The safing check section produces a safing output signal indicating that an impact has been applied in the predetermined direction when the safing detection value exceeds the safing reference value. The main acceleration sensor is provided separately from the acceleration sensor module for detecting an acceleration in the predetermined direction and producing a detection signal corresponding to detected acceleration. The microcomputer is connected to the safing acceleration sensor and the main acceleration sensor. The microcomputer includes a first main check section, a second main check section and an output section. The first main check section compares a first detection value calculated based on the detection signal of the safing acceleration sensor with a first reference value and produces a first output signal indicating that an impact has been applied in the predetermined direction when the first detection value exceeds the first reference value. The second main check section compares a second detection value calculated based on the detection signal of the main acceleration sensor with a second reference value and produces a second output signal indicating that an impact has been applied in the predetermined direction when the second detection value exceeds the second reference value. The output section outputs a determination signal only when both the first output signal and the second output signal are produced. The first switch section is connected to the acceleration sensor module and the microcomputer and configured to turn on to connect a passenger protection system to a power source only when both the safing output signal and the determination signal are applied thereto. The second switch section is connected to the microcomputer and configured to drive the passenger protection system with power from the power source in response to the determination signal, so that a passenger is protected from the impact.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram of an activation device for a passenger protection system according to a first embodiment of the present invention;

FIG. 2 is a circuit diagram of an acceleration sensor module provided in the activation device shown in FIG. 1;

FIG. 3 is a circuit diagram of an acceleration sensor module provided in an activation device according to a second embodiment of the present invention; and

FIG. 4 is a circuit diagram of the activation device including the acceleration sensor module shown in FIG. 3.

### DETAILED DESCRIPTION OF THE PREFERRED EMBODIMENT

The present invention will be described in more detail with reference to embodiments, in which the same or similar parts are designated by the same or similar numerals.

In the following embodiments, an activation device is provided for two passenger protection systems such as airbag systems in a vehicle, for example. The activation device is configured to activate the passenger protection systems equipped in the vehicle in response to collision impacts applied to the vehicle in one or both of the front-rear direction (longitudinal direction) and the left-right direction (lateral direction) of the vehicle.

### First Embodiment

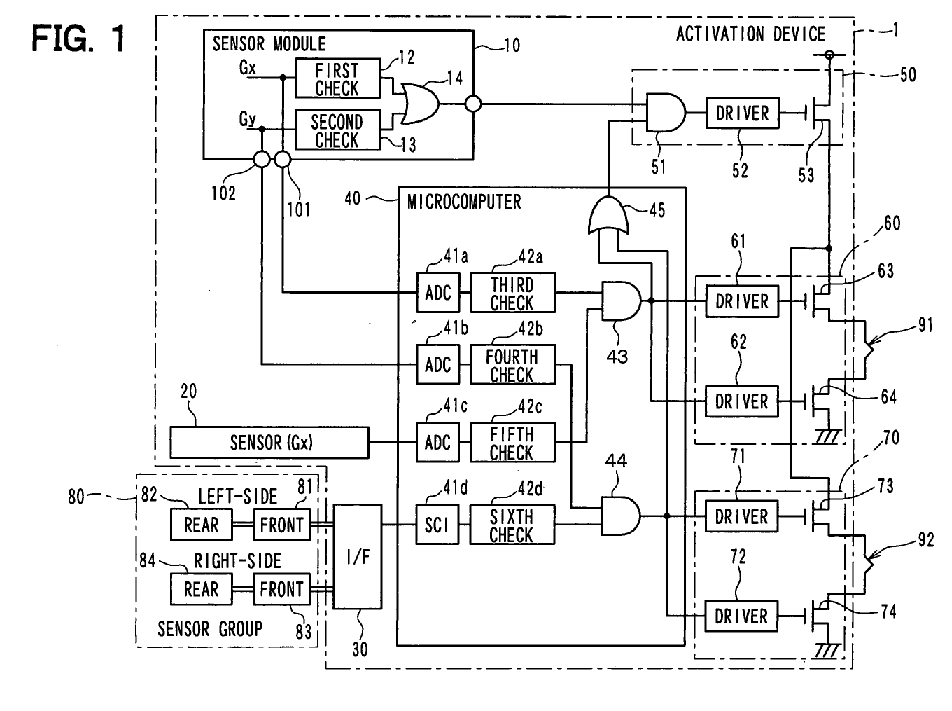

Referring to FIG. 1, an activation device 1 includes an acceleration sensor module 10, an in-vehicle acceleration sensor 20, a communications interface (I/F) 30, a microcomputer 40, a first switch section 50, a second switch section 60 and a third switch section 70.

The acceleration sensor module 10 is configured to detect accelerations (decelerations) caused by collision impact applied to the vehicle in two directions. One direction (first direction) is parallel to a first detection axis, which is set arbitrarily, and the other direction (second direction) is parallel to a second detection axis, which is set to be different from the first detection axis.

The first detection direction is set to be the longitudinal direction (front-rear direction) of the vehicle. The second detection direction is set to be the lateral direction (left-right direction) of the vehicle. Thus, the acceleration sensor module 10 is configured to detect accelerations in both the longitudinal direction and the lateral direction of the vehicle.

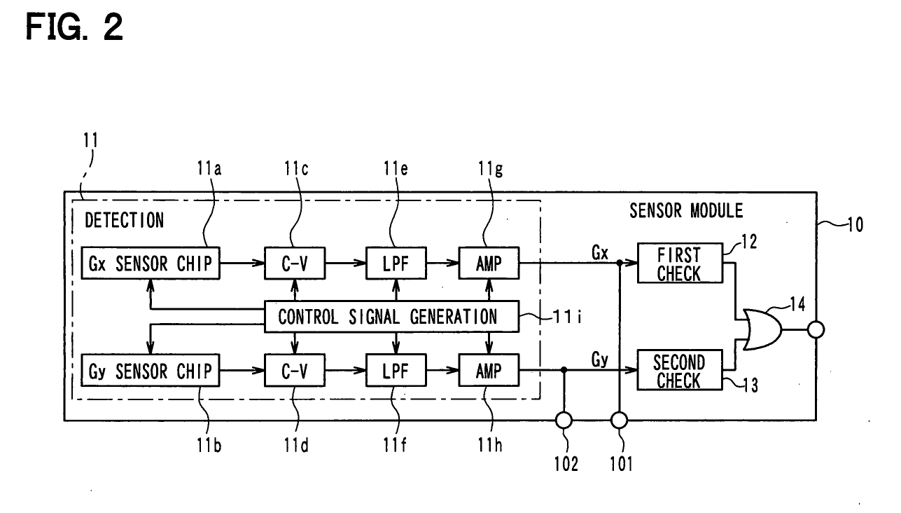

The acceleration sensor module 10 includes, as shown in FIG. 2 in detail, an acceleration detection section 11, a first collision check section 12, a second collision check section 13 and an OR circuit 14. The acceleration detection section 11 is not shown in FIG. 1.

The acceleration detection section 11 includes a Gx sensor chip 11a, a Gy sensor chip 11b, capacitance-voltage (C-V) conversion sections 11c, 11d, low-pass filters (LPFs) 11e, 11f, post-stage amplifiers 11g, 11h, and a control signal generation circuit 11i.

The Gx sensor chip 11a is configured to detect the acceleration (G) in the direction of the first detection axis (x), and the Gy sensor chip 11b is configured to detect the acceleration in the direction of the second detection axis (y). Each sensor chip 11a, 11b is manufactured as a MEMS device to generate a detection signal, which changes its amplitude in accordance with acceleration applied thereto.

Each sensor chip 11a, 11b may be formed in a beam structure body having a comb structure of a movable electrode and a fixed electrode, which is known well, on a silicon substrate or the like, so that a change in capacitance between the movable electrode and the fixed electrode is detected in accordance with the applied acceleration. Each sensor chip 11a, 11b produces the output signal, which varies with the change in the capacitance, to the corresponding C-V conversion section 11c, 11d.

Thus, the acceleration detection section 11 is provided with the Gx sensor chip 11a and the Gy sensor chip 11b to separately detect the accelerations applied in different impact detection directions (directions of collision detection axes) by the sensor chips 11a, 11b. That is, each sensor chip 11a, 11b can be used as a redundancy or back-up sensor in the activation device 1 for the passenger protection systems to ensure redundancy between the sensor chips 11a, 11b.

Each C-V conversion section 11c, 11d is configured to convert the capacitance change of the sensor chip 11a, 11b into the voltage. It may be configured by an operational amplifier, a C-V conversion capacitor or the like, although not shown in FIG. 2.

Each low-pass filter 11e, 11f is a filter circuit, which passes only low-frequency components of the voltage signal applied from the C-V conversion section 11c, 11d.

Each amplifier 11g, 11h is an amplifier circuit, which amplifies the voltage signal inputted from the low-pass filter 11e, 11f with a predetermined gain of amplification.

The control signal generation circuit 11i is configured to control the sensor chips 11a, 11b, the C-V conversion sections 11c, 11d, low-pass filters 11e, 11f and the amplifiers 11g, 11h. For example, the control signal generation circuit 11i produces to each sensor chip 11a, 11b a control signal, which indicates timing of application of a voltage to the fixed electrode. It further produces to each C-V conversion section 11c, 11d a control signal, which switches over charging and discharging of the C-V conversion capacitor.

The output signal produced by the Gx sensor chip 11a is processed by the C-V conversion section 11c, the low-pass filter 11e and the amplifier 11g and produced as a first detection signal from the amplifier 11g. Similarly, the output signal produced by the Gy sensor chip 11b is processed by the C-V conversion section 11d, the low-pass filter 11f and the amplifier 11h and produced as a second detection signal from the amplifier 11g.

The first detection signal is applied to the first collision check section 12 and outputted externally from the acceleration sensor module 10 through a terminal 101. The second detection signal is applied to the second collision check section 13 and outputted externally from the acceleration sensor module 10 through a terminal 102.

The first collision check section 12 is configured to check whether any impact has been applied in the first detection direction, that is, in the longitudinal direction of the vehicle. The first collision check section 12 therefore has a first threshold value to detect the collision impact applied in the first detection direction.

Specifically, the first collision check section 12 receives the first detection signal and integrates by interval the first detection signal. The integration output produced by integration of the first detection signal for a predetermined time interval is used as a first detection value. The first collision check section 12 then checks whether the first detection value exceeds the first threshold value by comparing the first detection value with the first threshold value, and produces a first collision check output signal indicative of the first collision check result. The first collision check output signal is a high-level signal (logical “1”), when the first detection value exceeds the second threshold value.

The second collision check section 13 is configured to check whether any impact has been applied in the second detection direction, that is, in the lateral direction of the vehicle. The second collision check section 13 therefore has a second threshold value to detect the collision impact applied in the second detection direction.

Specifically, the second collision check section 13 receives the second detection signal and integrates by interval the second detection signal. The integration output produced by integration of the second detection signal for a predetermined time interval is used as a second detection value. The second collision check section 13 then checks whether the second detection value exceeds the second threshold value by comparing the second detection value with the second threshold value, and produces a second collision check output signal indicative of the second collision check result. The second collision check output signal is a high-level signal (logical “1”), when the second detection value exceeds the second threshold value.

The OR circuit 14 receives the check output signals of the first collision check section 12 and the second collision check section 13 and produces an output signal (high-level signal, logical “1”) indicating a large impact when the received check output signals indicate that the first detection value exceeds the first threshold value or the second detection value exceeds the second threshold value.

This output signal only indicates that a large impact has been applied to the vehicle but does not indicate in which direction, the first detection direction or the second detection direction, the large impact has been applied. However, the acceleration sensor module 10 can produce its own check result indicating that an acceleration, which exceeds one of or both of first threshold value and the second threshold value, has been detected.

The in-vehicle acceleration sensor 20 shown in FIG. 1 is located in the vehicle compartment and configured to detect the acceleration Gx in the first detection direction (longitudinal direction). The in-vehicle acceleration sensor 20 may be configured in the same manner as each sensor chip 11a, 11b used in the acceleration sensor module 10. The acceleration detected by the in-vehicle acceleration sensor 20 is applied to the microcomputer 40 as a third detection signal.

The communications interface 30 receives output signals of an acceleration sensor group 80 provided on the vehicle and outputs them to the microcomputer 40.

The acceleration sensor group 80 includes a plurality of acceleration sensors, which respectively detect accelerations in the lateral direction of the vehicle. For example, the acceleration sensor group 80 includes a left-side Gy sensor group and a right-side Gy sensor group. The sensors are connected one another through a bus.

More specifically, the sensor group 80 includes four acceleration sensors.

For example, the left-side Gy sensor group includes an acceleration sensor 81 provided in correspondence to a first seat (front passenger seat) and an acceleration sensor 82 provided in correspondence to a second seat (rear passenger seat). Similarly, the right-side Gy sensor group includes an acceleration sensor 83 provided in correspondence to a first seat (driver seat) and an acceleration sensor 84 provided in correspondence to a second seat (rear passenger seat). These acceleration sensors 81 to 84 are located at pillars closest to respective seats in the compartment.

The acceleration sensors 81 to 84 of the acceleration sensor group 80 produce fourth detection signals, respectively. The fourth detection signals are different from sensor to sensor in the acceleration sensor group 80. The communications interface 30 is configured to output the four fourth detection signals of the acceleration sensor group 80 serially to the microcomputer 40.

The microcomputer 40 is configured to perform functions of A/D conversion processing, arithmetic calculation processing and amplification processing, as well as a function of outputting the processed signals to the first to third switch sections 50, 60 and 70.

Specifically, the microcomputer 40 receives the first detection signal and the second detection signals from the acceleration sensor module 10 through the terminals 101 and 102. The microcomputer 40 also receives the third detection signal from the in-vehicle acceleration sensor 20. The microcomputer 40 further receives the fourth detection signals from the acceleration sensor group 80.

The microcomputer 40 is configured to perform a front-rear main collision check as to whether any collision impact has been applied in the longitudinal direction of the vehicle by using the third detection signal. The microcomputer 40 is configured to perform a front-rear safing check as to whether any collision impact has been applied in the longitudinal direction of the vehicle by using the first detection signal. The microcomputer 40 is configured to output a longitudinal protection drive signal (high-level signal, logical “1”), when it determines the application of collision impact in the longitudinal direction based on the results of the front-rear main collision check and the front-rear safing check.

The microcomputer 40 is configured to perform a lateral main collision check as to whether any impact has been applied in the lateral direction of the vehicle by using the fourth detection signals. The microcomputer 40 is configured to perform a lateral safing check as to whether any impact has been applied in the lateral direction of the vehicle by using the second detection signal. The microcomputer 40 is configured to output a lateral protection drive signal (high-level signal, logical “1”) when it determines the application of collision impact in the lateral direction based on the results of the lateral impact main collision check and the lateral impact safing check.

The microcomputer 40 is further configured to output a determination signal (high-level signal, logical “1”), which is different from the longitudinal protection drive signal and the lateral protection drive signal and indicates the application of collision impact to the vehicle, when either one of or both of the longitudinal protection drive signal and the lateral protection drive signal is produced.

For performing these operations, the microcomputer 40 includes A/D converters (ADC), a serial communications interface (SCI) 41d, third to sixth collision check sections 42a to 42d, AND circuits 43, 44 and an OR circuit 45.

The A/D converters 41a to 41c convert analog voltage signals inputted thereto. The A/D converter 41a receives the first detection signal from the acceleration sensor module 10, A/D converts the same and outputs the A/D converted first detection signal to the third collision check section 42a. The A/D converter 41b receives the second detection signal from the acceleration sensor module 10, A/D converts the same and outputs the A/D converted second detection signal to the fourth collision check section 42b. The A/D converter 41c receives the third detection signal from the acceleration sensor module 10, A/D converts the same and outputs the A/D converted third detection signal to the fifth collision check section 42c.

The communications interface 41d receives the fourth detection signals serially into the microcomputer 40 by serial communications.

The third collision check section 42a and the fourth collision check section 42b are provided to perform safing check functions by using the first detection signal and the second detection signal produced from the acceleration sensor module 10.

Specifically, the third collision check section 42a receives the first detection signal from the A/D converter 41a and integrates by interval the first detection signal. The third collision check section 42a performs a front-rear safing check as to whether any impact has been applied in the longitudinal direction of the vehicle by comparing the integration value of the first detection signal with a predetermined threshold value provided in the third collision check section 42a.

The fourth collision check section 42b receives the second detection signal from the A/D converter 41b and integrates by interval the second detection signal. The fourth collision check section 42b performs a lateral safing check as to whether any impact has been applied in the lateral direction of the vehicle by comparing the integration value of the second detection signal with a predetermined threshold value provided in the fourth collision check section 42b.

The fifth collision check section 42c and the sixth collision check section 42d are provided to perform main collision check operations by using the third detection signal of the in-vehicle acceleration sensor 20 and the fourth detection signals of the acceleration sensor group 80.

Specifically, the fifth collision check section 42c receives the third detection signal from the A/D converter 41c and integrates by interval the third detection signal. The third collision check section 42c performs a longitudinal main collision check as to whether any impact has been applied in the longitudinal direction of the vehicle by comparing the integration value of the third detection signal with a predetermined threshold value provided in the fifth collision check section 42c.

The sixth collision check section 42d receives the fourth detection signals from the communications interface 41d and integrates by interval the fourth detection signals. The fourth collision check section 42d performs a lateral main collision check as to whether any impact has been applied in the lateral direction of the vehicle by comparing the integration values of the fourth detection signals with respective predetermined threshold values provided in the sixth collision check section 42b.

The predetermined threshold values are provided in the sixth collision check section 42d for the fourth detection signals, respectively, so that the fourth detection signals applied sequentially from the communications interface 30 are checked by using respective threshold values. The sixth collision check section 42d outputs a check result of a high-level signal (logical “1”) indicating the application of collision impact in the lateral direction of the vehicle, each time the integration value of the fourth detection signal exceeds the corresponding threshold value.

The AND circuit 43 is a logic circuit, which receives the check results of the third collision check section 42a and the fifth check result 42c and outputs the longitudinal protection drive signal (high-level signal, logical “1”) only when both the front-rear safing check result and the front-rear main collision check result indicate that impact has been applied in the longitudinal direction of the vehicle. One of input terminals of the AND circuit 43 is connected to the third collision check section 42a and the other of the input terminals of the same is connected to the fifth collision check section 42c.

The AND circuit 44 is also a logic circuit, which receives the check results of the fourth collision check section 42b and the sixth collision check section 42d and outputs the lateral protection drive signal (high level signal, logical “1”) only when both the lateral impact safing check result and the lateral impact main collision check result indicate that impact has been applied in the lateral direction of the vehicle. One of input terminals of the AND circuit 44 is connected to the fourth collision check section 42b and the other of the input terminals of the same is connected to the sixth collision check section 42d.

The OR circuit 45 outputs a determination signal (high-level signal, logical “1”) indicating that collision impact has been applied to the vehicle, when either one or both of the longitudinal protection drive signal or the lateral protection drive signal is applied thereto. This determination signal only indicates, like the output signal produced from the acceleration sensor module 10, that some large collision impact has been applied to the vehicle. It does not indicate in which direction of the longitudinal direction and the lateral direction the collision impact has been applied. This is a check result of the microcomputer 40 itself made separately from the acceleration sensor module 10.

The first switch section 50 is a switching means, which turns on and off based on both determination results of the acceleration sensor module 10 and the microcomputer 40.

The first switch section 50 includes an AND circuit 51, a driver circuit 52 and a transistor 53.

The AND circuit 51 is a logic circuit, which turns on the driver circuit 52 only when both of the output signal and the determination signal of high-level are inputted. The driver circuit 52 turns on the transistor 53, when turned on by the AND circuit 51.

The transistor 53 is a switching element, the gate, the drain and the source of which are connected to the driver circuit 52, the fixed potential source +V and both the second and third switch sections 60, 70.

The turn-on of the first switch section 50 indicates that the transistor 53 is turned on by the driver circuit 52 in response to application of both the output signal and the determination signal to the AND circuit 51.

The second switch section 60 is a switching means, which activates a squib 91 of a first passenger protection system, when the longitudinal protection drive signal is applied from the microcomputer 40. The second switch section 60 includes a driver circuits 61, 62 and transistors 63, 64.

The driver circuits 61, 62 turn on the transistors 63, 64, respectively, when turned on by the longitudinal protection drive signal of the AND circuit 43 of the microcomputer 40.

The gate, the drain and the source of the transistor 63 are connected to the driver circuit 61, the source of the transistor 53 of the first switch section 50 and the high side (positive side) of the squib 91, respectively. The gate, the drain and the source of the transistor 64 are connected to the driver circuit 62, the low side (negative side) of the squib 91 and the ground, respectively. The transistors 63, 64 are thus connected to supply an electric current to the squib 91, when turned on.

The first passenger protection system may be an airbag system, which inflates or expands in the longitudinal direction in the vehicle, for example.

Each transistor 63, 64 is connected in series to the squib 91, which has a gas generator for the airbag system. Thus, when the transistors 63, 64 are turned on, the squib 91 is supplied with the electric current so that a filament of the squib 91 is heated to fire and expand an airbag.

The second switch section 60 is connected to the fixed potential source +V through the first switch 50. Therefore, when the second switch section 60 is turned on with the first switch section 50 being turned on, the squib 91 is supplied with the electric current and activates the passenger protection system. If either one of the first switch section 50 and the second switch section 60 is in the turned-off condition, the passenger protection system is not activated.

The third switch section 70 is a switching means, which activates a squib 92 of a second passenger protection system, when the lateral protection drive signal is applied from the microcomputer 40. The second passenger protection system may also be an airbag system, which inflates or expands in the lateral direction in the vehicle, for example.

The third switch section 70 includes a driver circuits 71, 72 and transistors 73, 74. The driver circuits 71, 72 and the transistors 73, 74 are connected in the similar manner as in the second switch section 60.

The driver circuits 71, 72 turn on the transistors 73, 74, respectively, when turned on by the lateral protection drive signal of the AND circuit 44 of the microcomputer 40. The gate, the drain and the source of the transistor 73 are connected to the driver circuit 71, the source of the transistor 53 of the first switch section 50 and the high side (positive side) of the squib 92, respectively. The gate, the drain and the source of the transistor 74 are connected to the driver circuit 72, the low side (negative side) of the squib 92 and the ground, respectively. The transistors 73, 74 are thus connected to supply an electric current to the squib 92, when turned on.

As described above, the microcomputer 40 activates the first passenger protection system for protecting passengers in the longitudinal direction in the vehicle in response to the longitudinal protection drive signal with the first switch section 50 being turned on. The microcomputer 40 also activates the second passenger protection system for protecting passengers in the lateral direction in the vehicle in response to the lateral protection drive signal with the first switch section 50 being turned on.

The operation of the acceleration sensor module 10 and the activation system for the passenger protection systems using the acceleration sensor module 10 will be described below.

It is assumed that a large impact, which exceeds the predetermined threshold values, has been applied to the vehicle in the longitudinal direction.

In the acceleration sensor module 10, the first detection signal and the second detection signal produced by the sensor chips 11a, 11b of the acceleration detection section 11 are signal-processed by the C-V conversion sections 11c, 11d, low-pass filters 11a, 11f and the amplifiers 11g, 11h, respectively. The first detection signal and the second detection signal after the signal processing are inputted to the first collision check section 12 and the second collision check section 13, respectively.

The first collision check section 12 integrates the first detection signal for the predetermined interval, compares the first detection value corresponding to the first interval-integrated value with the first threshold value, and determines that the first detection value exceeds the first threshold value. The second collision check section 13 integrates the second detection signal for the predetermined interval, compares the second detection value corresponding to the second interval-integrated value with the second threshold value, and determines that the second detection value does not exceed the second threshold value.

The OR circuit 14 receives the check results of the first collision check section 12 and the second collision check section 13 and produces the output signal (logical “1”), because the check result of the first collision check section 12 indicates that the first detection value exceeds the first threshold value.

The microcomputer 40 also receives the first detection signal and the second detection signal from the acceleration sensor module 10.

The first detection signal is applied to the third collision check section 42a through the A/D converter 41a, and the third collision check section 42a performs the longitudinal impact safing check as to whether any impact has been applied to the vehicle in the longitudinal direction. Specifically, the third collision check section 42a integrates the first detection signal for the predetermined interval and determines that the integration value exceeds the third threshold value provided in the third collision check section 42a. This check result is inputted to the AND circuit 43 as the high-level signal (logical “1”).

The second detection signal is applied to the fourth collision check section 42b through the A/D converter 41b, and the fourth collision check section 42b performs the lateral impact safing check as to whether any impact has been applied to the vehicle in the lateral direction. Specifically, the fourth collision check section 42b integrates the second detection signal for the predetermined interval and determines that the integration value does not exceed the threshold value provided in the fourth collision check section. This check result is inputted to the AND circuit 44 as the low-level signal (logical “0”).

The microcomputer 40 further receives the third detection signal from the in-vehicle acceleration sensor 20 and the fourth detection signals from the acceleration sensor group 80 through the communications interface 30.

The third detection signal is applied to the fifth collision check section 42c through the A/D converter 41c, and the fifth collision check section 42c performs the longitudinal impact main collision check as to whether any impact has been applied to the vehicle in the longitudinal direction. The fifth collision check section 42c integrates the third detection signal for the predetermined interval and determines that the integration value exceeds the fifth threshold value provided in the fifth collision check section 42c. This determination result is inputted to the AND circuit 43 as the high-level signal (logical “1”).

The fourth detection signals are applied to the sixth collision check section 42d through the communications interface 41d, and the sixth collision check section 42c performs the lateral impact main collision check as to whether any impact has been applied to the vehicle in the lateral direction. Since the fourth detection signals are different from sensor to sensor in the acceleration sensor group 80, the sixth collision check section 42d integrates each of the fourth detection signals sequentially applied thereto for the predetermined interval and determines that the integration values do not exceed the predetermined threshold values provided in correspondence to the plurality of sensors. This check result is inputted to the AND circuit 44 as the low-level signal (logical “0”).

The AND circuit 43 receives the check results of the fifth collision check section 42c and the third collision check section 42a. Since the check results are both “1,” which indicates that the impact has been applied to the vehicle in the longitudinal direction, the AND circuit 43 outputs the longitudinal protection drive signal (logical “1”).

The AND circuit 44 receives the check results of the sixth collision check section 42d and the fourth collision check section 42b. Since the check results are both “0,” which indicates that the impact has not been applied to the vehicle in the lateral direction, the AND circuit 44 does not output the lateral protection drive signal. The OR circuit 45 receives the longitudinal protection drive signal from the AND circuit 43 but does not receive the lateral protection drive signal from the AND circuit 44.

That is, since the OR circuit 45 receives one of the longitudinal protection drive signal and the lateral protection drive signal, it outputs the determination signal of high level (logical “1”).

The AND circuit 51 of the first switch section 50 receives the output signal from the acceleration sensor module 10 and the determination signal from the microcomputer 40, the driver circuit 52 turns on the transistor 53 in response to the output of the AND gate 51. Thus the first switch section 50 is turned on.

When the first switch section 50 is turned on, the first and the second passenger protection systems are rendered to be ready for activation by the second switch section 60 and the third switch section 70 connected to the first switch section 50. The activation of the first passenger protection system is possible only when the first switch section 50 is in the turned-on condition, which is determined by the determination output of the acceleration sensor module 10 and the determination output of the microcomputer 40.

Since the longitudinal protection drive signal (logical “1”) is applied from the AND circuit 43 to the driver circuits 61, 62 of the second switch section 60, the transistors 63, 64 are turned on. Since the first switch section 50 is in the turned-on condition at this moment, an electric current flows from the fixed potential source +V to the ground through the squib 91. Thus, the squib 91 connected to the transistors 63, 64 is fired to activate the first passenger protection system in the longitudinal direction in the vehicle.

Since the lateral protection drive signal (logical “1”) is not applied from the AND circuit 44 to the driver circuits 71, 72 of the third switch section 70, the transistors 73, 74 are not turned on. As a result, the second passenger protection system for lateral protection is not activated.

The above operation is made with respect to a case, in which the collision impact has been applied in the longitudinal direction of the vehicle.

The operation is similar in a case, in which collision impact has been applied in the lateral direction of the vehicle.

In case of the lateral collision, the first collision check section 12 determines that the first detection value does not exceed the first threshold value. The second collision check section 13 determines that the second detection value exceeds the second threshold value. The OR circuit 14 receives the check result (logical “1”) of the second collision check section 13 and produces the output signal (logical “1”), which indicates that the second detection value exceeds the second threshold value.

In the microcomputer 40, the third collision check section 42a integrates the first detection signal for the predetermined interval and determines that the integration value does not exceed the third threshold value provided in the third collision check section 42a. This check result is inputted to the AND circuit 43 as the low-level signal (logical “0”).

The fourth collision check section 42b integrates the second detection signal for the predetermined interval and determines that the integration value exceeds the fourth threshold value provided in the fourth collision check section 42b. This check result is inputted to the AND circuit 44 as the high-level signal (logical “1”).

The fifth collision check section 42c integrates the third detection signal for the predetermined interval and determines that the integration value does not exceed the threshold value provided in the fifth collision check section 42c. This determination result is inputted to the AND circuit 43 as the low-level signal (logical “0”). The sixth collision check section 42d integrates the fourth detection signals sequentially applied thereto for the predetermined interval and determines that the integration values exceed the sixth predetermined threshold values.

Thus, the sixth collision check section 42d outputs the determination result (logical “1”), which indicates that impact has been applied in the lateral direction of the vehicle, when the integration values of all the four detection signals exceed the respective threshold values.

This is just one example of check operation of the sixth collision check section 42c. The sixth collision check section 42d may be configured to output a determination result, which indicates that a part of the integration values of the four detection signals exceeds the corresponding threshold value.

The AND circuit 43 receives the check results of the fifth collision check section 42c and the third collision check section 42a. Since the check results are both “0,” which indicates that the collision impact has not been applied to the vehicle in the longitudinal direction, the AND circuit 43 does not output the longitudinal protection drive signal (logical “1”).

The AND circuit 44 receives the check results of the sixth collision check section 42d and the fourth collision check section 42b. Since the check results are both “1,” which indicates that the impact has been applied to the vehicle in the lateral direction, the AND circuit 44 outputs the lateral protection drive signal (logical “1”).

The OR circuit 45 does not receive the longitudinal protection drive signal from the AND circuit 43 but receives the lateral protection drive signal from the AND circuit 44. As a result, the OR circuit 45 outputs the determination signal (logical “1”).

The AND circuit 51 of the first switch section 50 receives the output signal (logical “1”) from the acceleration sensor module 10 and the determination signal (logical “1”) from the microcomputer 40. Thus, the first switch section 50 turns on.

Since the lateral protection drive signal is applied from the AND circuit 44 to the driver circuits 71, 72 of the third switch section 70, the transistors 73, 74 are turned on.

Thus, the electric current flows from the fixed potential source +V to the ground through the squib 92. As a result, the squib 92 of the second passenger protection system connected to the transistors 73, 74 is fired to activate the second passenger protection system for protecting passengers in the lateral direction.

Since the longitudinal protection drive signal is not applied from the AND circuit 43 to the driver circuits 61, 62 of the second switch section 60, the transistors 63, 64 are not turned on. As a result, the first passenger protection system for longitudinal protection is not activated.

In the event that the collision impact has been applied in both the longitudinal direction and the lateral direction exceeding respective threshold values, both of the above-described operations for protecting the passengers in the longitudinal direction and the lateral direction are performed.

In this instance, in the acceleration sensor module 10, the OR circuit 14 receives the determination results (both logical “1”) indicating the application of collision impact from both the first collision check section 12 and the second collision check section 13, and produces the output signal. In the microcomputer 40, the OR circuit 45 receives the longitudinal protection drive signal (logical “1”) from the AND circuit 43 and the lateral protection drive signal (logical “1”) from the AND circuit 44.

As described above, the first switch section 50 is turned on and both the second switch section 60 and the third switch section 70 are turned on as well. Thus, both passenger protection systems for protecting passengers in the longitudinal direction and the lateral direction are activated.

The first switch section 50 is not turned on, when none of the AND circuit 43 and the AND circuit 44 output the longitudinal protection drive signal and the lateral protection drive signal in correspondence to the check results of the third to sixth collision check sections 42a to 42d.

Since the current path between the fixed potential source +V and the ground is interrupted by the first switch section 50, none of the passenger protection systems is activated.

Even if the microcomputer 40 applies the determination signal (logical “1”) to the first switch section 50 and the second switch section 60 or the third switch section 70, the first switch section 50 is not turned on unless the acceleration sensor module 10 produces the output signal (logical “1”). As a result, the passenger protection systems are not activated.

According to the first embodiment, as described above, the acceleration sensor module 10 has sensor chips 11a and 11b, which separately detect accelerations in different impact detection directions.

The Gx sensor chip 11a detects the acceleration Gx in the longitudinal direction of the vehicle, and the Gy sensor chip 11b detects the acceleration Gy in the lateral direction of the vehicle. Each sensor chip 11a, 11b can be used as a redundancy sensor.

As a result, an acceleration sensor and a microcomputer for ensuring redundancy of the activation device for a passenger protection system, and hence the activation device 1 for the passenger protection system can be simplified in configuration.

In addition, the acceleration sensor module 10 is provided with the check function to output a check result, which indicates whether any impact has been applied or not. As a result, even if the microcomputer 40 is the single one provided in the activation device 1 for the passenger protection system, the passenger protection system can be activated by using the check result of the acceleration sensor module 10 as well in addition to the determination result of the microcomputer 40. That is, since the first switch section 50 is turned on or off based on both the output signal of the acceleration sensor module 10 and the determination signal of the microcomputer 40, the passenger protection system is protected from being activated by only the determination of the microcomputer 40 even when the microcomputer 40 runs erroneously. The passenger protection system is thus protected from being activated erroneously without using two microcomputers 40.

### Second Embodiment

The second embodiment is described with respect to only parts, which are different from the first embodiment.

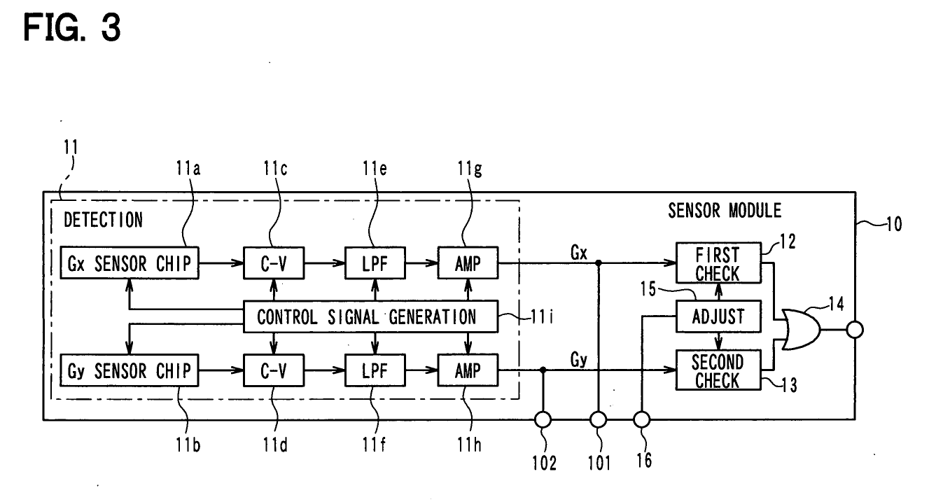

As shown in FIG. 3, the acceleration sensor module 10 is provided with an adjust circuit 15. The adjust circuit 15 adjusts either one or both of the first threshold value provided in the first collision check section 12 and the second threshold value provided in the second collision check section 13. The acceleration sensor module 10 is provided with an input terminal 16 for receiving an external adjustment signal for the adjust circuit 15. The external adjustment signal includes either one or both of a new first threshold value to be set in the first collision check section 12 and a new second threshold value to be set in the second collision check section 13. The acceleration sensor module 10 provided with the adjust circuit 15 is used in the activation device 1.

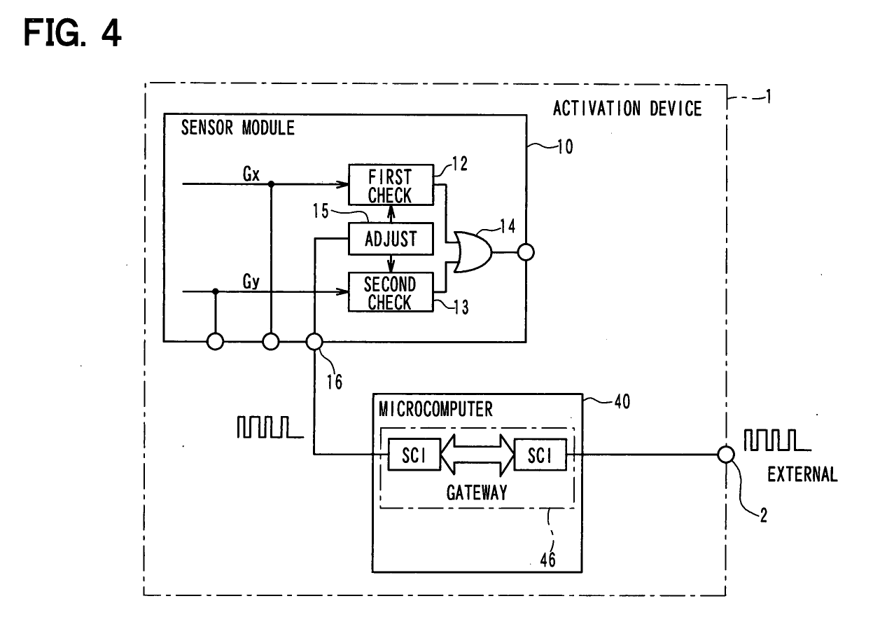

As shown in FIG. 4, the microcomputer 40 is provided with a transfer circuit 46. The transfer circuit 46 is configured to transfer the external adjustment signal applied from the outside to the adjust circuit 15 of the acceleration sensor module 10. The transfer circuit 46 may be configured with serial communications interfaces and a gateway. The transfer circuit 46 operates to transfer the external adjustment signal, which is applied to an external input terminal 2 of the activation device 1 from the outside, to the acceleration sensor module 10 through the microcomputer 40.

According to this configuration, when the external adjustment signal is inputted to the external input terminal 2 of the activation device 2, it is transferred to the acceleration sensor module 10 through the transfer circuit 46 of the microcomputer 40. Specifically, the external adjustment signal is inputted to the adjust circuit 15 through the input terminal 16 of the acceleration sensor module 10. The first threshold value of the first collision check section 12 and/or the second threshold value of the second collision check section 13 are updated to the new threshold values transferred from the microcomputer 40.

As described above, since the adjust circuit 15 is provided in the module 15, the first threshold value of the first collision check circuit 12 and the second threshold value of the second collision check circuit 13, which has already been set, can be changed to different threshold values from the external side. Since the first threshold value and the second threshold values are changeable, the versatility of the acceleration sensor module 10 can be enhanced.

Since the magnitude of collision impact, which a vehicle receives, varies from type to type of from model to model of vehicles, the activation device 1 need be variably set in correspondence to different vehicles. However, since the threshold values of the first collision check section 12 and the second collision check section 13 are adjustable by the adjust circuit 15, the activation device 1 can be adapted to different types or models of vehicle.

### Other Embodiments

In the foregoing embodiments, the number of the acceleration sensors provided in the acceleration sensor module 10 is not limited to two but may be three or more. The check section will be provided for each acceleration sensor.

Each switch section 50, 60, 70 may be configured differently from the above-described configuration.

The activation device 1 may be configured to activate three or more passenger protection systems in addition to the two passenger protection systems provided to protect a passenger in the longitudinal direction and lateral direction.

The number of acceleration sensors provided in the acceleration sensor group 80 may be different from vehicle to vehicle. The number of acceleration sensors for detecting acceleration applied to the vehicle in the lateral direction is not limited to plural but may be one.

The application of the external adjustment signal to the acceleration sensor module 10 is not limited to transfer by the transfer circuit 46 of the microcomputer 40 but may be direct input to the acceleration sensor module 10 That is, the threshold values of the first collision check section 12 and the second collision check section 13 may be adjusted by inputting the external adjustment signal to the adjust circuit 15 of the acceleration sensor module 10 from the outside without the transfer circuit 46 of the microcomputer 40.

The activation device 1 may be configured for only one passenger protection system. In this case, only one of acceleration sensors 11a, 11b may be provided in the acceleration sensor module 10 as a safing sensor, and only one of sensors 20, 80 may be provided as a main acceleration sensor.

What is claimed is:

1. An acceleration sensor module comprising:
an acceleration detection section including a first acceleration sensor and a second acceleration sensor, the first acceleration sensor detecting an acceleration in a first direction parallel to a first detection axis, the second acceleration sensor detecting an acceleration in a second direction parallel to a second detection axis, which is different from the first detection axis, the acceleration detection section configured to output a first detection signal corresponding to the acceleration detected by the first acceleration sensor and a second detection signal corresponding to the acceleration detected by the second acceleration sensor;
a first collision check section having a first threshold value for checking whether an impact has been applied in the first direction, the first collision check section configured to receive the first detection signal and check whether a first detection value corresponding to the first detection signal exceeds the first threshold value;
a second collision check section having a second threshold value for checking whether an impact has been applied in the second direction, the second collision check section being configured to receive the second detection signal and check whether a second detection value corresponding to the second detection signal exceeds the second threshold value; and
an output section configured to receive check results of the first collision check section and the second collision check section and produce an output signal when at least one of the check results indicates that the first detection value exceeds the first threshold value or the second detection value exceeds the second threshold value.

2. The acceleration sensor module according to claim 1, further comprising:
an adjust section configured to variably adjust at least one of the first threshold value and the second threshold value.

3. An activation device for passenger protection systems comprising:
the acceleration sensor module according to claim 1;
a third acceleration sensor for detecting an acceleration in a longitudinal direction of a vehicle as the first direction and outputting a third detection signal corresponding to a detected acceleration;
a fourth acceleration sensor for detecting an acceleration in a lateral direction of the vehicle as the second direction and outputting a fourth detection signal corresponding to a detected acceleration;
a microcomputer configured to perform a longitudinal main collision check based on the third detection signal thereby checking whether an impact has been applied in the longitudinal direction of the vehicle and a longitudinal safing check based on the first detection signal thereby checking whether an impact has been applied in the longitudinal direction of the vehicle, the microcomputer outputting a longitudinal protection drive signal in response to both check results of the longitudinal impact main collision check and the longitudinal safing check indicating that the impact has been applied in the longitudinal direction;
the microcomputer configured to perform a lateral main collision check based on the fourth detection signal thereby checking whether an impact, has been applied in the lateral direction of the vehicle and a lateral safing check based on the second detection signal thereby checking whether an impact has been applied in the lateral direction of the vehicle, the microcomputer outputting a lateral protection drive signal in response to both check results of the lateral impact main collision check and the lateral impact safing check indicating that the impact has been applied in the lateral direction;
the microcomputer further configured to output a determination signal indicating that the impact has been applied to the vehicle in response to at least one of the longitudinal protection drive signal and the lateral protection drive signal;
a first switch section configured to turn on when both the output signal and the determination signal are applied;
a second switch section configured to drive a first passenger protection system in response to the longitudinal protection drive signal with the first switch being in a turned-on condition, so that a passenger is protected from the impact applied in the longitudinal direction; and
a third switch section configured to drive a second passenger protection system in response to the lateral protection drive signal with the first switch being in the turned-on condition, so that a passenger is protected from the impact applied in the lateral direction.

4. The activation device for passenger protection systems according to claim 3, further comprising:
an adjust section configured to variably adjust at least one of the first threshold value and the second threshold value,
wherein the microcomputer includes a transfer section for transferring, to the adjust section, data applied externally for updating the first threshold value and the second threshold value.

5. An activation device for a passenger protection system of a vehicle, the activation device comprising:
an acceleration sensor module including a safing acceleration sensor and a safing check section, the safing acceleration sensor detecting an acceleration in a predetermined direction and producing a detection signal corresponding to detected acceleration, the safing check section comparing a safing detection value calculated based on the detection signal of the safing acceleration sensor with a safing reference value, the safing check section producing a safing output signal indicating that an impact has been applied in the predetermined direction when the safing detection value exceeds the safing reference value;
a main acceleration sensor provided separately from the acceleration sensor module for detecting an acceleration in the predetermined direction and producing a detection signal corresponding to detected acceleration;
a microcomputer connected to the safing acceleration sensor and the main acceleration sensor, the microcomputer including a first main check section, a second main check section and an output section, the first main check section comparing a first detection value calculated based on the detection signal of the safing acceleration sensor with a first reference value and producing a first output signal indicating that an impact has been applied in the predetermined direction when the first detection value exceeds the first reference value, the second main check section comparing a second detection value calculated based on the detection signal of the main acceleration sensor with a second reference value and producing a second output signal indicating that an impact has been applied in the predetermined direction when the second detection value exceeds the second reference value, and the output section outputting a determination signal only when both the first output signal and the second output signal are produced;
a first switch section connected to the acceleration sensor module and the microcomputer and configured to turn on to connect a passenger protection system to a power source only when both the safing output signal and the determination signal are applied thereto; and
a second switch section connected to the microcomputer and configured to drive the passenger protection system with power from the power source in response to the determination signal, so that a passenger is protected from the impact.

6. The activation device according to claim 5, wherein:
the safing check section and the first main check section integrate the detection signal of the safing acceleration sensor in calculation of the safing detection value and the first detection value, respectively; and
the second main check section integrates the detection signal of the main acceleration sensor in calculation of the second detection value.
